(19) United States
(12) Patent Application Publication
(10) Pub. No.: US 2026/0276027 A1
(43) Pub. Date: Sep. 17, 2026

(54) SINGLE-BOLT QUICK-INSTALL NUT

(71) Applicant: GLOBE UNION INDUSTRIAL CORP., Taichung City (TW)

(72) Inventor: CHAO-TA YANG, Taichung City (TW)

(73) Assignee: GLOBE UNION INDUSTRIAL CORP., Taichung City (TW)

(21) Appl. No.: 19/561,547

(22) Filed: Mar. 10, 2026

(30) Foreign Application Priority Data
Mar. 13, 2025 (CN) 202520437908.2

(51) Int. Cl. F16B 37/08; E03C 1/04

(52) U.S. Cl. CPC F16B 37/0864; E03C 1/0401

(57) ABSTRACT

A single-bolt quick-install nut includes a sleeve housing having an engaging ring and a first urging portion that are formed at an interval along a central axis. A screwing member passes into the sleeve housing. The screwing member has an engaging hook for hooking onto the engaging ring. A partial threaded portion is provided inside the screwing member and a lateral channel penetrates through a portion of the screwing member adjacent to the partial threaded portion. An actuated hole is formed at an end of the screwing member. A pressing member that could return to an original position is slidably disposed on the lateral channel. The pressing member has a second urging portion that is slidable along the first urging portion in a direction oblique to the central axis.

### BACKGROUND OF THE INVENTION

### Technical Field

The present invention relates generally to a fixing device, and more particularly to a single-bolt quick-install nut.

### Description of Related Art

A structure including a conventional nut for securing a faucet is illustrated in FIG. 19. When a faucet 50 is mounted to a basin or a sink, the faucet 50 is engaged with a bolt 52. After the bolt 52 extends downward through the basin or the sink, a bottom plate 54 abuts against a bottom side of the basin or the sink and is sleeved around the bolt 52. A nut 56 is engaged with the bolt 52. By the nut 56 abutting against the bottom plate 54, the bottom plate 54 could support the bottom side of the basin or the sink. In this way, the faucet 50 could be fixed on the basin or the sink.

The aforementioned structure could secure the faucet on the basin or the sink by engaging the nut with the bolt to support the bottom plate. However, space below the basin or the sink is typically limited. Moreover, rotating the nut with a nut wrench requires sufficient space around the nut for operation of the nut wrench. As a result, the aforementioned structure that uses the nut to urge the bottom plate for securing the faucet is inconvenient to operate and still has room for improvement.

### BRIEF SUMMARY OF THE INVENTION

In view of the above, the primary objective of the present invention is to provide a nut structure that could be quickly installed onto a bolt and could be operated using an L-shaped wrench or other straight tools, thereby enabling a user to fasten the nut structure onto a bolt within a confined operation space. When the nut structure of the present invention abuts and supports a basin, a sink, or other objects, the nut structure of the present invention could be securely engaged with a faucet or tank that is engaged with another end of the bolt.

The present invention provides a single-bolt quick-install nut including a sleeve housing, a screwing member, and a pressing member. The sleeve housing has an engaging ring and an axial hole. The axial hole extends along a central axis. A first urging portion is formed on an inner peripheral wall of the axial hole. The engaging ring and the first urging portion are spaced from each other along the central axis.

The screwing member includes a first tube section, a second tube section, and a third tube section that are coaxially arranged and are sequentially connected along the central axis. An outer diameter of the first tube section is less than an outer diameter of the second tube section. An end edge of the first tube section that faces away from the second tube section is connected to an engaging hook. The first tube section passes through the axial hole and the engaging hook is hooked onto a side of the engaging ring that faces away from the first urging portion. A lateral channel is formed and penetrates through a side of a periphery of the first tube section and a side of a periphery of the second tube section. A pair of recesses is formed in an outer peripheral wall of the second tube section at two circumferential sides of the lateral channel. A partial threaded portion is formed on a portion of an inner peripheral wall of the first tube section and a portion of an inner peripheral wall of the second tube section that are free of the lateral channel. An actuated hole is formed inside the third tube section. The actuated hole is a non-circular hole.

The pressing member has a body that is fitted into the lateral channel and is radially slidable with respect to the central axis. A pressing portion is formed on a side of the body that faces the partial threaded portion. Another side of the body that faces away from the partial threaded portion protrudes outward relative to the lateral channel. A second urging portion is formed on the another side of the body that faces away from the partial threaded portion. The second urging portion is configured to abut against the first urging portion. The second urging portion is slidable along the first urging portion in a direction oblique to the central axis. A pair of radial elastic pieces is formed on two circumferential sides of the body. Each of the radial elastic pieces is elastic and abuts against a corresponding one of the recesses.

When the present invention is used, the single-bolt quick-install nut is sleeved onto a bolt that is connected to an object. The bolt passes through a mounting location at which the object is mounted, and the single-bolt quick-install nut is engaged with the bolt via the partial threaded portion of the screwing member. The screwing member could be rotated directly or by inserting an L-shaped wrench into the actuated hole, so that while the sleeve housing abuts against the mounting location at which the object is mounted, the screwing member simultaneously moves toward the sleeve housing.

When the sleeve housing and the screwing member relatively move toward each other, the second urging portion of the pressing member is urged by the first urging portion of the sleeve housing to slide along the first urging portion in the direction oblique to the central axis, so that the body of the pressing member moves into the lateral channel and the pressing portion of the pressing member cooperates with the partial threaded portion of the screwing member to press the bolt. In this way, the present invention could be fastened to the bolt and, via the sleeve housing, abut against the mounting location at which the object is mounted, thereby providing an effect of securing the object to the mounting location.

With the aforementioned design, the single-bolt quick-install nut of the present invention could be operated using an L-shaped wrench or other straight tools, thereby facilitating the user to fasten the single-bolt quick-install nut to the bolt so as to abut against the mounting location at which the object is mounted, such as a basin, a sink, or a tank seat of a toilet. In this way, the object engaged with the another end of the bolt, such as a faucet or a tank, could be secured to the basin, the sink, or the tank seat of the toilet.

### BRIEF DESCRIPTION OF THE SEVERAL VIEWS OF THE DRAWINGS

The present invention would be best understood by referring to the following detailed description of some illustrative embodiments in conjunction with the accompanying drawings, in which

FIG. 1 is a perspective view of the single-bolt quick-install nut according to a first embodiment of the present invention;

FIG. 2 is an exploded view of the single-bolt quick-install nut according to the first embodiment of the present invention;

FIG. 3 is a side view of the single-bolt quick-install nut according to the first embodiment of the present invention;

FIG. 4 is a sectional view along the 4-4 line in FIG. 3;

FIG. 5 is a top view of the single-bolt quick-install nut according to the first embodiment of the present invention;

FIG. 6 is a sectional view along the 6-6 line in FIG. 5;

FIG. 7 is a schematic view showing the single-bolt quick-install nut according to the first embodiment of the present invention in an operation state;

FIG. 8 is a sectional schematic view showing the single-bolt quick-install nut according to the first embodiment of the present invention in the operation state;

FIG. 9 is a perspective view the single-bolt quick-install nut according to a second embodiment of the present invention;

FIG. 10 is a top view of the single-bolt quick-install nut according to the second embodiment of the present invention;

FIG. 11 is a sectional view along the 11-11 in FIG. 10;

FIG. 12 is a perspective view of the single-bolt quick-install nut according to a third embodiment of the present invention;

FIG. 13 is a sectional schematic view of the single-bolt quick-install nut according to the third embodiment of the present invention;

FIG. 14 is a perspective view of the single-bolt quick-install nut according to a fourth embodiment of the present invention;

FIG. 15 is an exploded view of the single-bolt quick-install nut according to the fourth embodiment of the present invention;

FIG. 16 is a top view of the single-bolt quick-install nut according to the fourth embodiment of the present invention;

FIG. 17 is a sectional view along the 17-17 line in FIG. 16;

FIG. 18 is a sectional schematic view showing the single-bolt quick-install nut according to the fourth embodiment of the present invention in an operation state; and

FIG. 19 is a schematic view showing that a conventional nut is mounted onto a faucet.

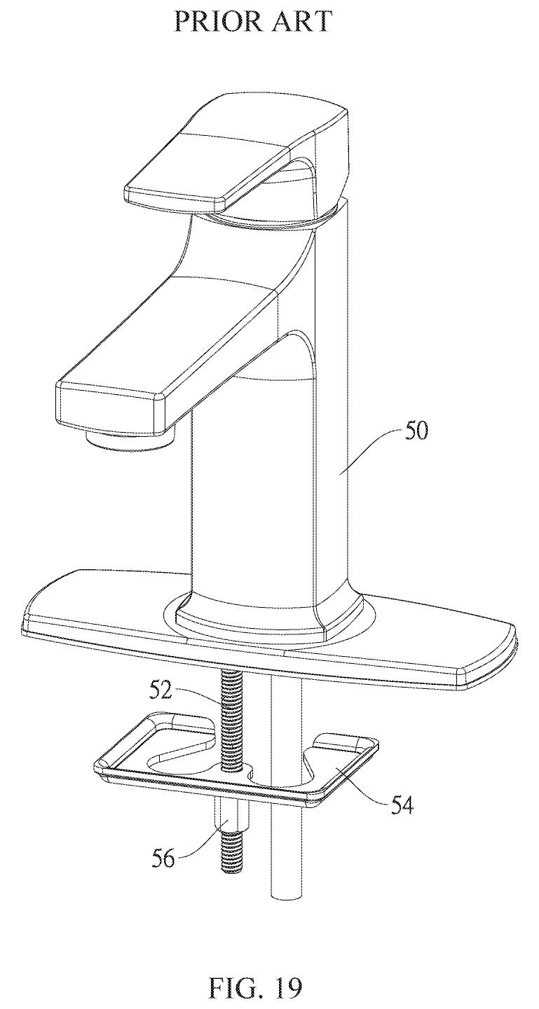

### DETAILED DESCRIPTION OF THE INVENTION

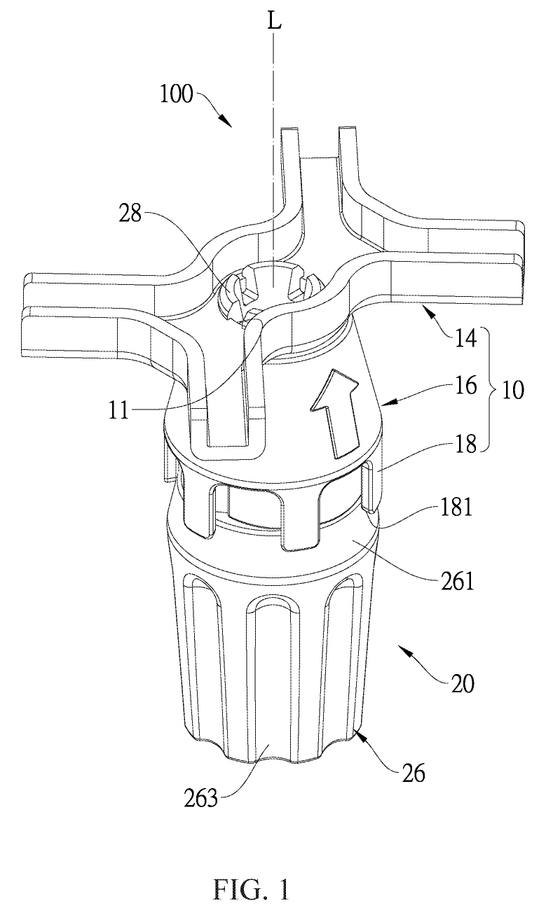

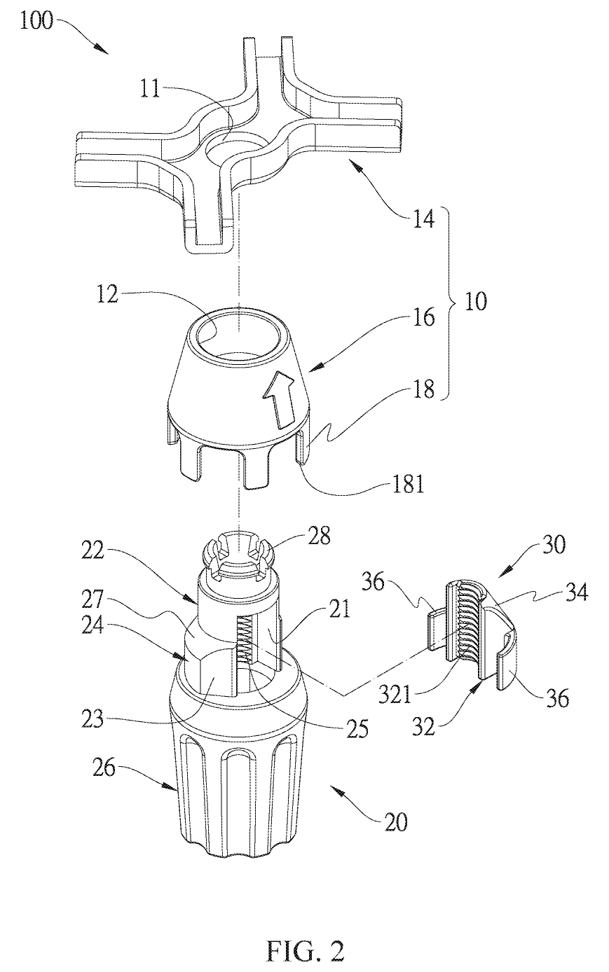

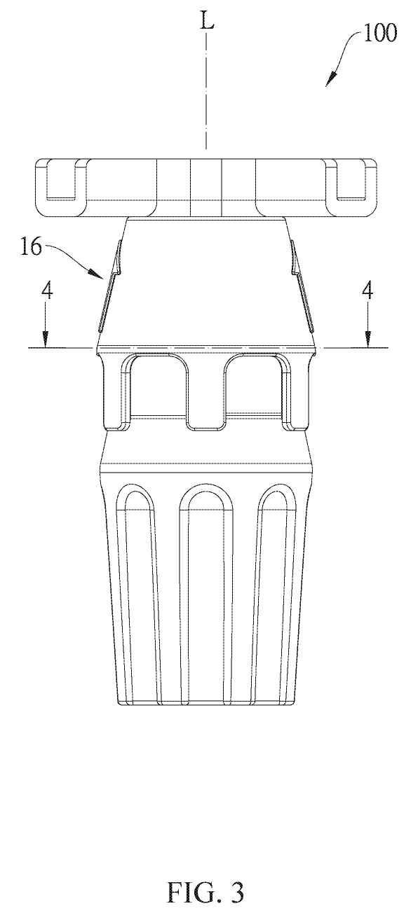

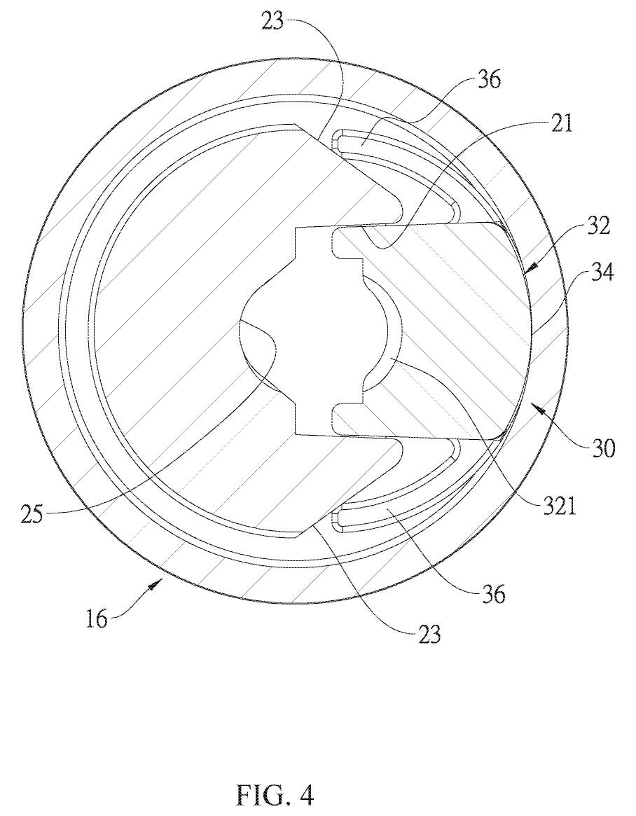

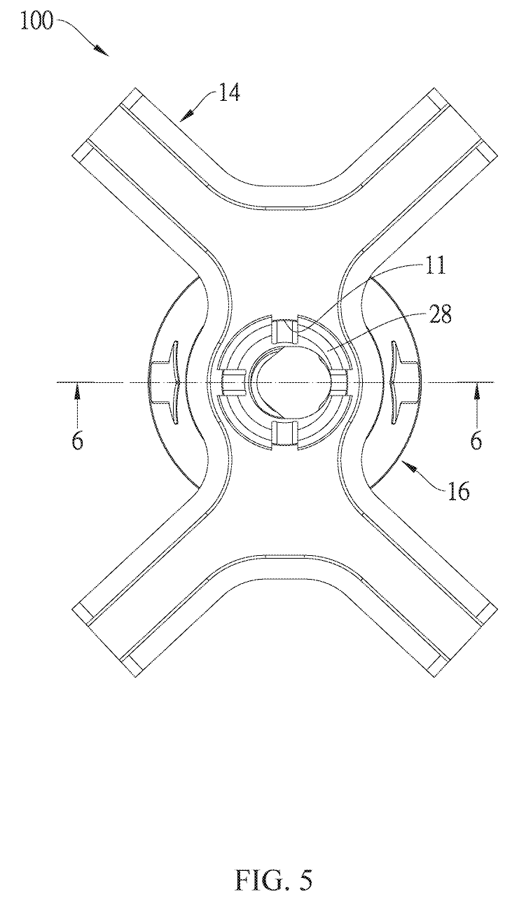

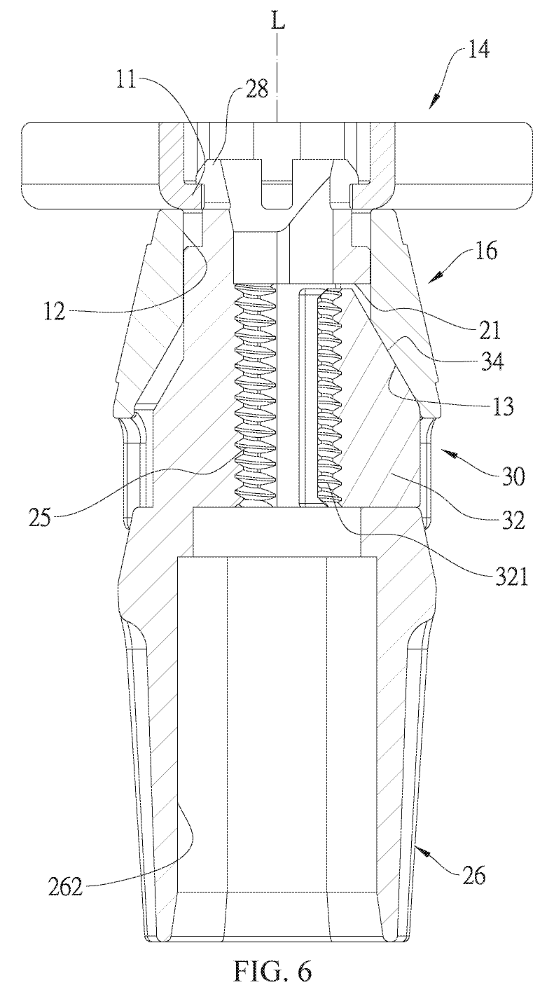

A single-bolt quick-install nut 100 according to a first embodiment of the present invention is illustrated in FIGS. 1 to 6. The single-bolt quick-install nut 100 has a central axis L and includes a sleeve housing 10, a screwing member 20, and a pressing member 30. In the following description of the single-bolt quick-install nut 100, two opposite sides of the central axis L are respectively defined as a top side and a bottom side.

The sleeve housing 10 is centered on the central axis L and has an engaging ring 11 and an axial hole 12. In the current embodiment, the sleeve housing 10 includes a gasket 14, a cap 16, and a plurality of axial elastic pieces 18. The gasket 14 is a X-shaped plate and the engaging ring 11 is formed at a middle of the gasket 14. The middle of the gasket 14 abuts against a top end of the cap 16. The axial hole 12 is formed on an inner side of the cap 16. A first urging portion 13 is formed on a side of the axial hole 12 that faces away from the gasket 14. In the current embodiment, the first urging portion 13 is an annular conical surface, and an inner diameter of a side of the first urging portion 13 that is close to the gasket 14 is less than an inner diameter of another side of the first urging portion 13 that is away from the gasket 14. The engaging ring 11 and the first urging portion 13 are spaced from each other along the central axis L. An end edge of the cap 16 facing away from the gasket 14, i.e., a bottom end edge of the cap 16, is connected to the axial elastic pieces 18. The axial elastic pieces 18 are parallel to the central axis L and are arranged in a circle. Each of the axial elastic pieces 18 is an elastic piece and has a free end 181.

The screwing member 20 is a straight tube centered on the central axis L. The screwing member 20 includes a first tube section 22, a second tube section 24, and a third tube section 26 that are coaxially arranged and are sequentially connected along the central axis L. An outer diameter of the first tube section 22 is less than an outer diameter of the second tube section 24. The outer diameter of the second tube section 24 is less than an outer diameter of the third tube section 26. An end edge of the first tube section 22 that faces away from the second tube section 24 is connected to an engaging hook 28. The first tube section 22 passes through the axial hole 12 of the sleeve housing 10. The engaging hook 28 is hooked onto a side of the engaging ring 11 that faces away from the first urging portion 13. In other words, the engaging hook 28 is hooked onto a top side of the engaging ring 11.

A lateral channel 21 is formed on a side of a periphery of the first tube section 22 and a side of a periphery of the second tube section 24. The lateral channel 21 is a rectangular hole. The lateral channel 21 radially penetrates the side of the periphery of the first tube section 22 and the side of the periphery of the second tube section 24 with respect to the central axis L, so that the lateral channel 21 communicates with an interior of the first tube section 22 and an interior of the second tube section 24. A pair of recesses 23 is formed in an outer peripheral wall of the second tube section 24 at two circumferential sides of the lateral channel 21. A partial threaded portion 25 is formed on a portion of an inner peripheral wall of the first tube section 22 and a portion of an inner peripheral wall of the second tube section 24 that are free of the lateral channel 21. A partial inclined surface 27 is formed on an outer peripheral wall of a portion of the second tube section 24 that is adjacent to the first tube section 22. The partial inclined surface 27 is an arcuate conical surface and is spaced apart from the first urging portion 13 of the sleeve housing 10.

The third tube section 26 extends outward from the axial hole 12 of the sleeve housing 10. A supporting surface 261 is formed on an outer peripheral wall of a portion of the third tube section 26 that is adjacent to the second tube section 24. The supporting surface 261 is an annular conical surface. An outer diameter of a side of the supporting surface 261 that is adjacent to the second tube section 24 is less than an outer diameter of another side of the supporting surface 261 that is away from the second tube section 24. The end edge of the cap 16 configured to connect the axial elastic pieces 18 could be described as the end edge of the cap 16 that faces away from the gasket 14 or an end edge of the cap 16 that is close to the supporting surface 261. The axial elastic pieces 18 connected to the cap 16 abut against the supporting surface 261 via the free ends 181 of the axial elastic pieces 18. In this way, when the sleeve housing 10 and the screwing member 20 are driven by an external force to move toward each other, the supporting surface 261 pushes the axial elastic pieces 18 along the central axis L and drives the axial elastic pieces 18 to bend and deform, so that when the external force that moves the sleeve housing 10 and the screwing member 20 toward each other is dismissed, restoring forces of the axial elastic pieces 18 could push the sleeve housing 10 away from the screwing member 20, thereby enabling the sleeve housing 10 and the screwing member 20 to return to original positions.

An actuated hole 262 is formed inside the third tube section 26. The actuated hole 262 is a hexagonal hole. The actuated hole 262 communicates with a space surrounded by the partial threaded portion 25. In other embodiments, the actuated hole 262 could also be a square hole or other pentagonal holes, or a star-shaped hole or other non-circular holes, as long as the actuated hole 262 could be inserted by a corresponding wrench for driving the screwing member 20 to rotate. A plurality of anti-slip grooves 263 is formed in an outer peripheral wall of the third tube section 26. The anti-slip grooves 263 are arranged around the central axis L. The anti-slip grooves 263 could provide friction to help a user hold the third tube section 26, so that the user could easily rotate the screwing member 20 by rotating the third tube section 26.

The pressing member 30 has a body 32. The body 32 is a block having a shape matching the lateral channel 21. The body 32 is mounted onto the lateral channel 21 and is radially slidable with respect to the central axis L. A pressing portion 321 is formed on a side of the body 32 that faces the partial threaded portion 25. In the current embodiment, the pressing portion 321 is a portion of a thread and could cooperate with the partial threaded portion 25 of the screwing member 20 to jointly form a complete thread. In other embodiments, the pressing portion 321 could also be a portion of a tube wall.

The pressing portion 321 is basically flush with the inner peripheral wall of the second tube section 24. In other embodiments, the pressing portion 321 could be slightly recessed relative to the inner peripheral wall of the second tube section 24; in other words, the pressing portion 321 could be located within the lateral channel 21. Another side of the body 32 that faces away from the partial threaded portion 25, i.e., an outer side of the body 32, protrudes outward relative to the lateral channel 21. A second urging portion 34 is formed on a portion of the outer side of the body 32 that faces the first urging portion 13. The second urging portion 34 is configured to abut against the first urging portion 13. The second urging portion 34 could be spaced apart from the first urging portion 13. An interval between the partial inclined surface 27 and the first urging portion 13 is greater than an interval between the second urging portion 34 and the first urging portion 13. In the current embodiment, the second urging portion 34 is an arcuate conical surface and abuts against the first urging portion 13. In this way, when the sleeve housing 10 and the screwing member 20 move toward each other, the pressing member 30 is driven by the screwing member 20 to move toward the sleeve housing 10, so that the second urging portion 34 could slide along the first urging portion 13 in a direction oblique to the central axis L.

A pair of radial elastic pieces 36 is formed on two circumferential sides of the body 32. The radial elastic pieces 36 are elastic and respectively abut against the pair of recesses 23 of the screwing member 20. In this way, when the sleeve housing 10 and the screwing member 20 are driven by the external force to move toward each other, the pressing member 30 is driven by the screwing member 20 to move toward the sleeve housing 10, so that the second urging portion 34 of the pressing member 30 is urged by the first urging portion 13. Therefore, the body 32 is driven to radially move into the screwing member 20 with respect to the central axis L, and the pressing portion 321 is driven to move to a position that protrudes inward relative to the inner peripheral wall of the second tube section 24, thereby enabling the pressing portion 321 to cooperate with the partial threaded portion 25 to press and engage with a bolt located inside the screwing member 20. At the same time, the recesses 23 push the radial elastic pieces 36 to bend and deform, so that when the sleeve housing 10 and the screwing member 20 return to the original positions and the second urging portion 34 is not urged by the first urging portion 13, restoring forces of the radial elastic pieces 36 could push the body 32 of the pressing member 30 to return to an original position. At that time, the pressing portion 321 no longer presses the bolt.

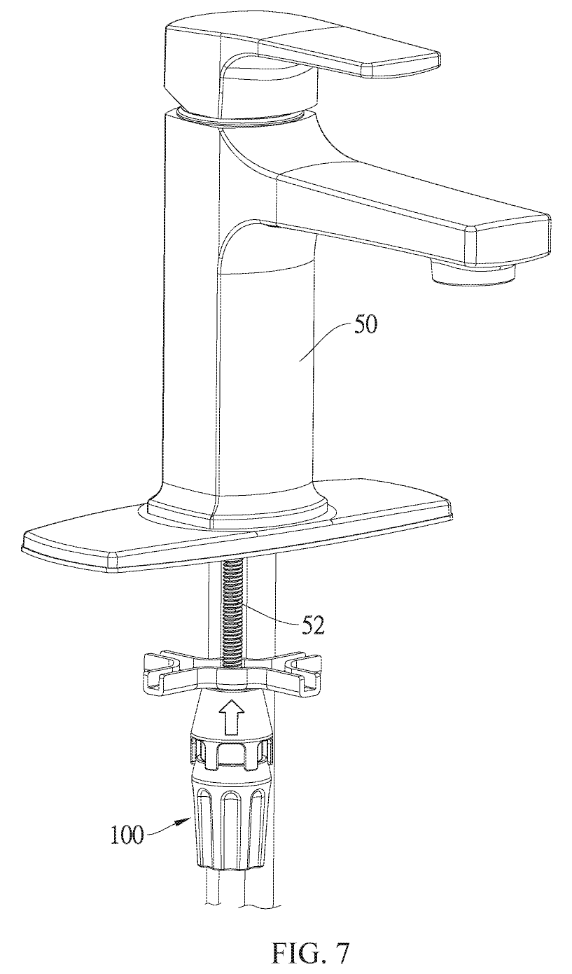

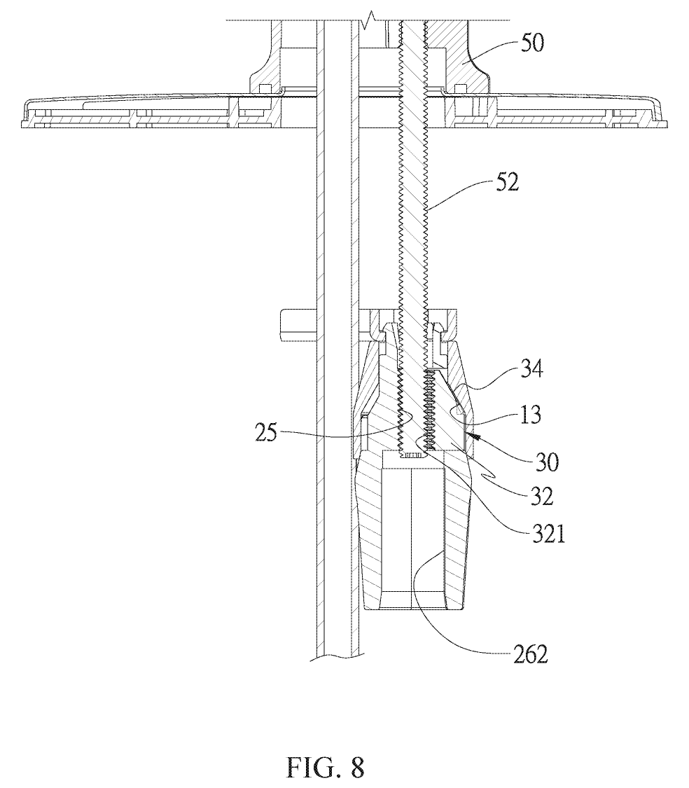

Referring to FIGS. 1, 2, and 6 to 8, when the single-bolt quick-install nut 100 of the first embodiment is used, the sleeve housing 10 is located on a top side of the single-bolt quick-install nut 100 and the screwing member 20 is located on a bottom side of the single-bolt quick-install nut 100. When the single-bolt quick-install nut 100 is used to secure a faucet 50, the faucet 50 is mounted on a basin or a sink, the faucet 50 is engaged with a bolt 52, and the bolt 52 extends downward through the basin or the sink. The single-bolt quick-install nut 100 is sleeved around the bolt 52. The bolt 52 passes through the sleeve housing 10 and could be loosely engaged with the partial threaded portion 25 of the screwing member 20. The gasket 14 of the sleeve housing 10 slightly abuts against a bottom side of the basin or the sink.

Afterward, an L-shaped wrench is inserted into the actuated hole 262 for rotating the screwing member 20. Alternatively, the user could rotate the third tube section 26 with hands to rotate the screwing member 20. In this way, while the sleeve housing 10 abuts against the bottom side of the basin or the sink through which the bolt 52 passes, the screwing member 20 is rotated and moved toward the sleeve housing 10 simultaneously as the screwing member 20 is engaged with the bolt 52, thereby pushing the sleeve housing 10 toward the bottom side of the basin or the sink. While the screwing member 20 moves in a direction toward the sleeve housing 10, the second urging portion 34 of the pressing member 30 is urged by the first urging portion 13 of the sleeve housing 10, so that the second urging portion 34 slides along the first urging portion 13 in the direction oblique to the central axis L, thereby driving the body 32 of the pressing member 30 to move relatively into the lateral channel 21. Finally, the pressing portion 321 cooperates with the partial threaded portion 25 of the screwing member 20 to press the bolt 52, so that the single-bolt quick-install nut 100 is fastened to the bolt 52, and simultaneously, the gasket 14 of the sleeve housing 10 tightly abuts against the bottom side of the basin or the sink to provide a supporting effect, thereby securely positioning the faucet 50 on the basin or the sink.

When the single-bolt quick-install nut 100 is required to be detached from the bolt 52, the screwing member 20 is inversely rotated and the axial elastic pieces 18 abutting against the supporting surface 261 provide the restoring forces, so that the screwing member 20 relatively moves in a direction away from the sleeve housing 10. At that time, the first urging portion 13 of the sleeve housing 10 no longer urges the second urging portion 34 of the pressing member 30, so that the pressing portion 321 releases the bolt 52. At that time, the single-bolt quick-install nut 100 could be withdrawn from the bolt 52. While the single-bolt quick-install nut 100 is withdrawn from the bolt 52, the restoring forces provided by the radial elastic pieces 36 on the two sides of the pressing member 30 drive the body 32 to leave the lateral channel 21, thereby preventing the pressing portion 321 from obstructing the movement of the bolt 52 within the screwing member 20. With the aforementioned design, while the single-bolt quick-install nut of the present invention is fastened to the bolt 52, the installation could be completed by rotating the screwing member 20 by an L-shaped wrench or hands, so that the user could easily operate the single-bolt quick-install nut within a confined space, and the single-bolt quick-install nut 100 could be quickly fastened to the bolt 52, thereby enhancing convenience.

In the first embodiment of the present invention, the sleeve housing 10 is provided to include two detachable components, namely the gasket 14 and the cap 16. In other embodiments, the sleeve housing 10 could be provided as an integral structure, as exemplified in a second embodiment of the present invention.

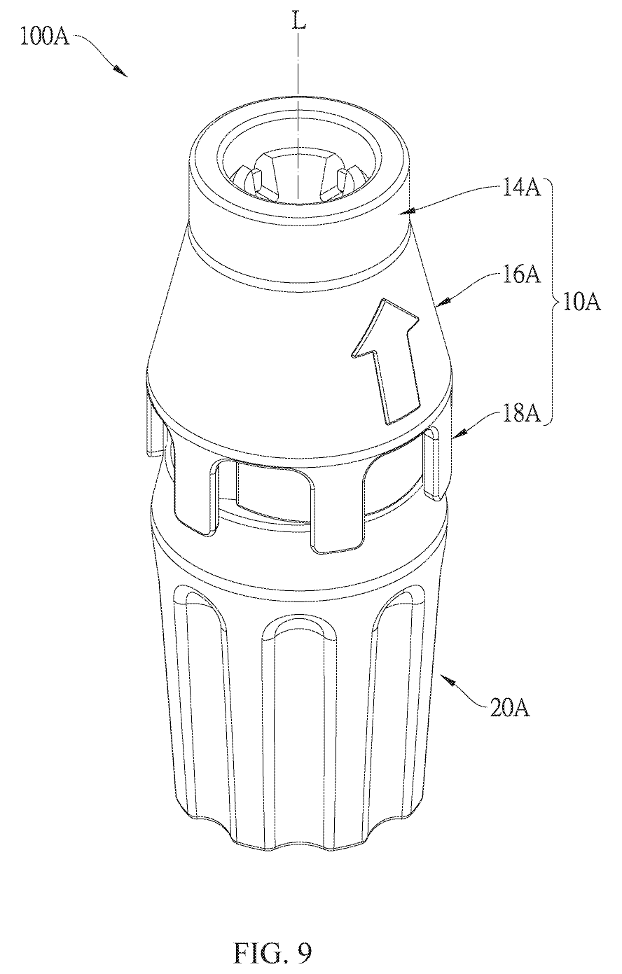

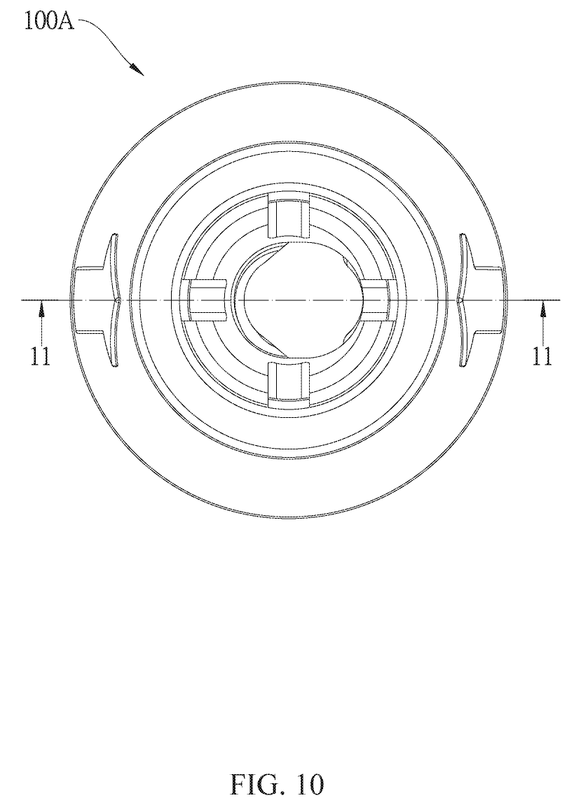

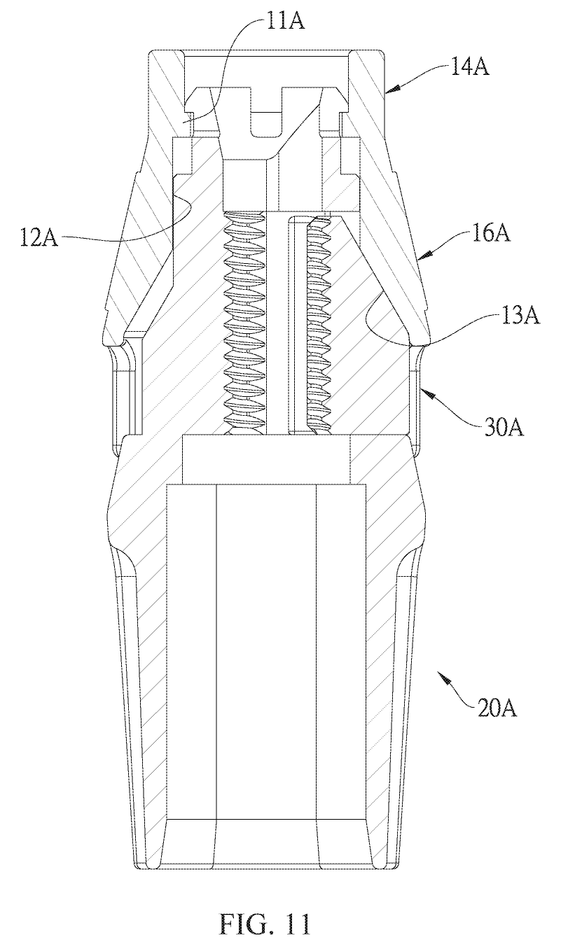

A single-bolt quick-install nut 100A according to the second embodiment of the present invention is illustrated in FIGS. 9 to 11 and is similar to the single-bolt quick-install nut 100 of the first embodiment to include a sleeve housing 10A, a screwing member 20A, and a pressing member 30A. The sleeve housing 10A is centered on a central axis L and has an axial hole 12A. The sleeve housing 10A includes a straight tube 14A, a cap 16A, and a plurality of axial elastic pieces 18A. The straight tube 14A is a tube and is coaxial with the cap 16A. The straight tube 14A is integrally connected to an end of the cap 16A that faces away from the axial elastic pieces 18A, i.e., the straight tube 14A is connected to a top end of the cap 16A.

An engaging ring 11A is formed in an inner peripheral wall of the straight tube 14A. The axial hole 12A is formed on an inner side of the cap 16A. A first urging portion 13A is formed on a side of the axial hole 12A that faces away from the straight tube 14A. The first urging portion 13A is an annular conical surface. An end edge of the cap 16A that faces away from the straight tube 14A is connected to the axial elastic pieces 18A. The axial elastic pieces 18A are elastic pieces parallel to the central axis L and are arranged in a circle.

The structures of the screwing member 20A and the pressing member 30A, the engagement relationship between the screwing member 20A, the pressing member 30A, and the sleeve housing 10A, and the functions of the single-bolt quick-install nut 100A formed by engaging the screwing member 20A, the pressing member 30A, and the sleeve housing 10A according to the second embodiment of the present invention are the same as that of the first embodiment of the present invention.

In the first embodiment of the present invention, the first urging portion 13 of the sleeve housing 10 is provided as an annular conical surface. In other embodiments, the first urging portion 13 could be modified into different shapes, such that after the first urging portion 13 is abutted by the second urging portion 34 of the pressing member 30, the first urging portion 13 could slide in a direction oblique to the central axis L, as exemplified in a third embodiment of the present invention.

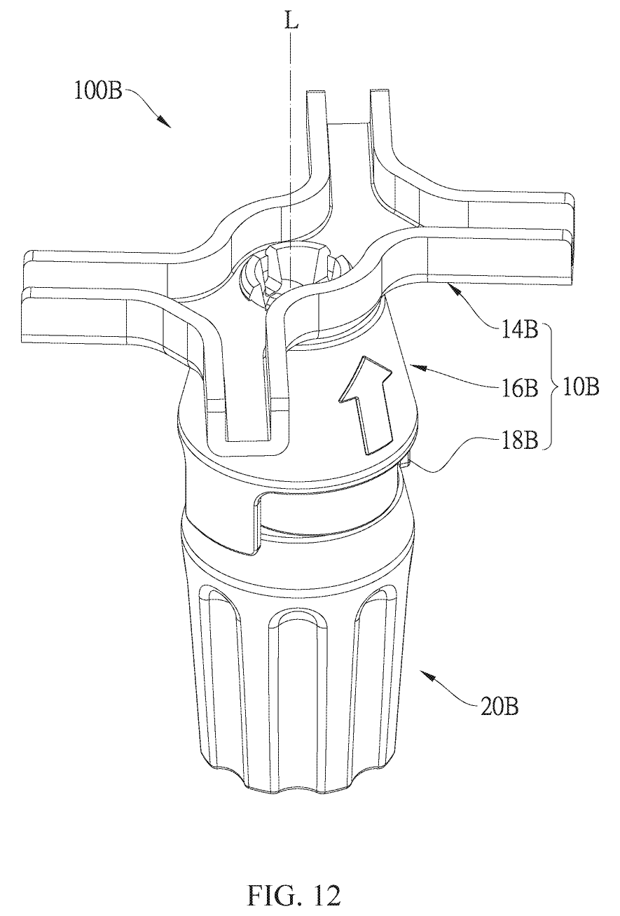

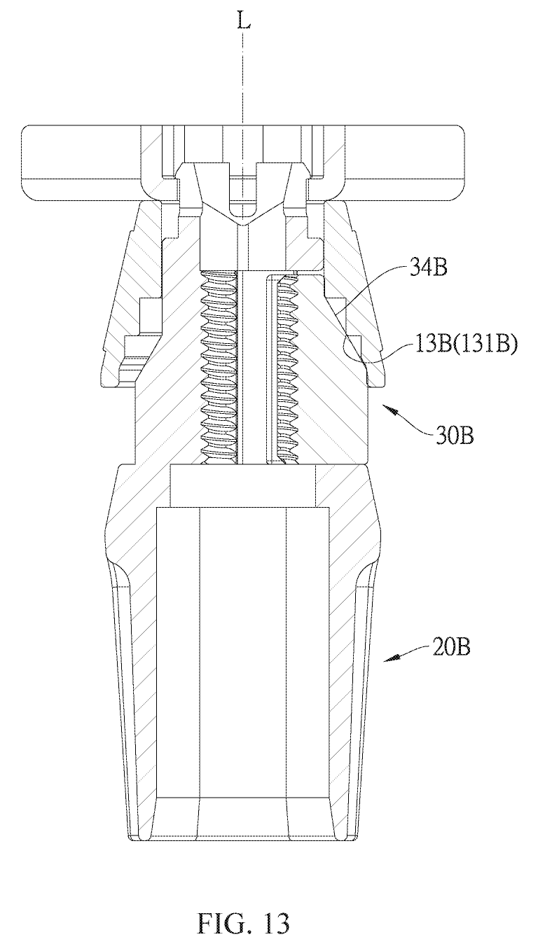

A single-bolt quick-install nut 100B according to the third embodiment of the present invention is illustrated in FIGS. 12 and 13 and similarly includes a sleeve housing 10B, a screwing member 20B, and a pressing member 30B. The sleeve housing 10B similarly includes a gasket 14B, a cap 16B, and a plurality of axial elastic pieces 18B. The gasket 14B abuts against a top end of the cap 16B. The axial elastic pieces 18B are connected to a bottom end edge of the gasket 14B. The single-bolt quick-install nut 100B of the third embodiment is characterized in that an inner side of the cap 16 B of the sleeve housing 10B is provided with a first urging portion 13B. The first urging portion 13B includes a plurality of circular edges 131B arranged at intervals along the central axis L. The circular edges 131B are coaxial. The farther each circular edges 131B is from the gasket 14B (and the engaging ring thereof), the larger a diameter of the circular edge 131B is. The circular edges 131B are configured to abut against the second urging portion 34B of the pressing member 30B.

The structures of a remaining portion of the gasket 14B, the structures of the screwing member 20B and the pressing member 30B, the engagement relationship between the screwing member 20B, the pressing member 30B, and the sleeve housing 10B, and the functions of the single-bolt quick-install nut 100B formed by engaging the screwing member 20B, the pressing member 30B, and the sleeve housing 10B according to the third embodiment of the present invention are the same as that of the first embodiment of the present invention.

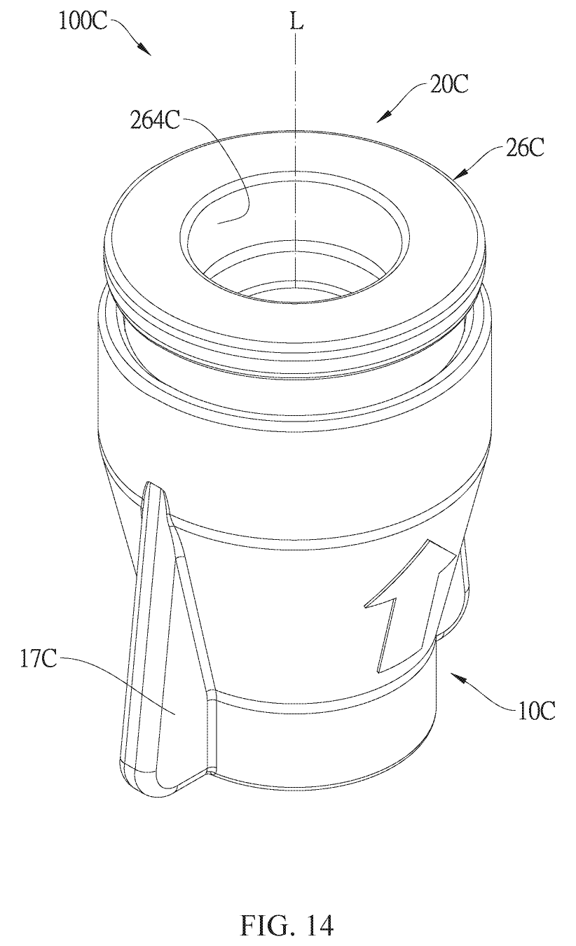

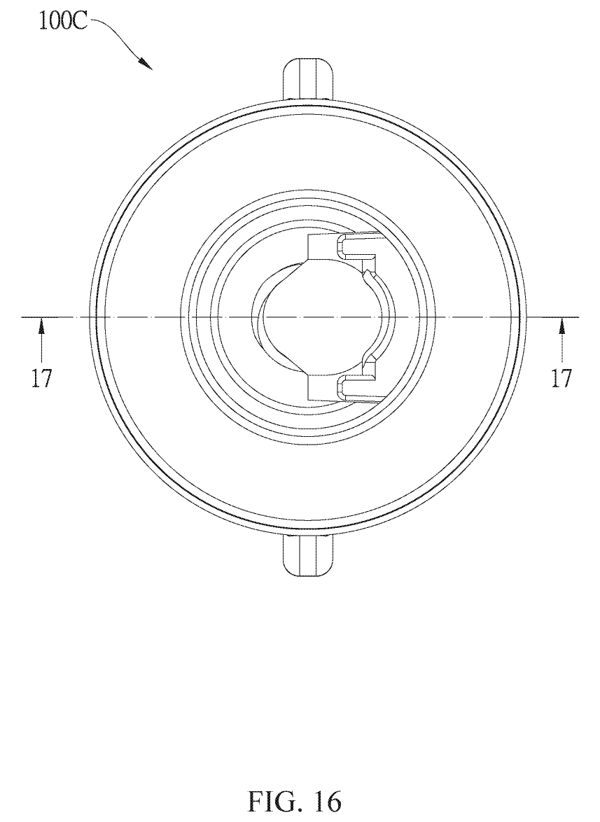

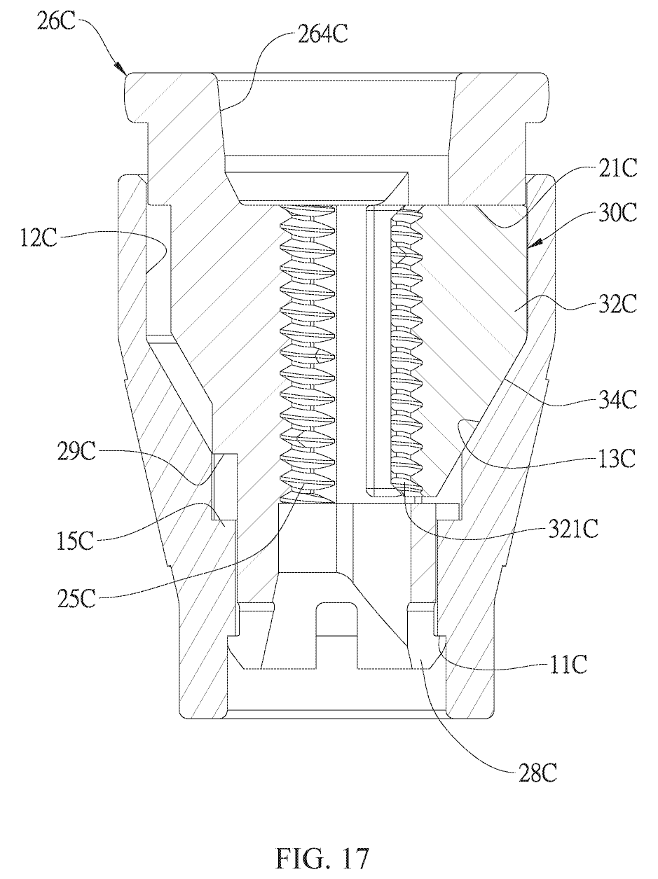

In the first embodiment to the third embodiment of the present invention, the sleeve housing is located on a top side of the single-bolt quick-install nut and the screwing member is located on a bottom side of the single-bolt quick-install nut. In a fourth embodiment of the present invention, a single-bolt quick-install nut could be invertedly designed when used. A single-bolt quick-install nut 100C according to the fourth embodiment of the present invention is illustrated in FIGS. 14 to 17. The single-bolt quick-install nut 100C of the fourth embodiment has a central axis L and includes a sleeve housing 10C, a screwing member 20C, and a pressing member 30C.

The sleeve housing sleeve housing 10C is centered on the central axis L and has an axial hole 12C. An engaging ring 11C, a plurality of sliding blocks 15C, and a first urging portion 13C are formed on an inner peripheral wall of the axial hole 12C along the central axis L. The engaging ring 11C and the first urging portion 13C are spaced apart from each other along the central axis L. The sliding blocks 15C are elongated blocks arranged along the central axis L and are located between the engaging ring 11C and the first urging portion 13C. The sliding blocks 15C are arranged at intervals around the central axis L. An end of each of the sliding blocks 15C is connected to a side of the engaging ring 11C that faces the first urging portion 13C. The first urging portion 13C is an annular conical surface. An inner diameter of a side of the first urging portion 13C that is adjacent to the engaging ring 11C is less than an inner diameter of another side of the first urging portion 13C that is away from the engaging ring 11C. A pair of operating blocks 17C is formed on two sides of an outer peripheral wall of the sleeve housing 10C.

The screwing member 20C is a straight tube centered on the central axis L. The screwing member 20C includes a first tube section 22C, a second tube section 24C, and a third tube section 26C that are coaxially arranged and are sequentially connected along the central axis L. An outer diameter of the first tube section 22C is less than an outer diameter of the second tube section 24C. The outer diameter of the second tube section 24C is less that an outer diameter of the third tube section 26C. An end edge of the first tube section 22C that faces away from the second tube section 24C is connected to an engaging hook 28C. The first tube section 22C passes through the axial hole 12C of the sleeve housing 10C. The engaging hook 28C is hooked onto a side of the engaging ring 11C that faces away from the first urging portion 13C. A plurality of rails 29C is formed on an end edge of the first tube section 22C that faces away from the second tube section 24C and is circumferentially arranged. The rails 29C are elongated grooves extending along the central axis L and respectively receive the sliding blocks 15C, so that the sliding blocks 15C are slidable within the rails 29C along the central axis L. In this way, the screwing member 20C could move back and forth in a direction toward the axial hole 12C along the central axis L. The rails 29C of the screwing member 20C receives the sliding blocks 15C, so that when the sleeve housing 10C rotates about the central axis L, the screwing member 20C is driven to rotate simultaneously.

A lateral channel 21C is formed on a side of a periphery of the first tube section 22C and a side of a periphery of the second tube section 24C. The lateral channel 21C is a rectangular hole. The lateral channel 21C radially penetrates the side of the periphery of the first tube section 22C and the side of the periphery of the second tube section 24C with respect to the central axis L, so that the lateral channel 21C communicates with an interior of the first tube section 22C and an interior of the second tube section 24C. A pair of recesses 23C is formed in an outer peripheral wall of the second tube section 24C at two circumferential sides of the lateral channel 21C. A partial threaded portion 25C is formed on a portion of an inner peripheral wall of the first tube section 22C and a portion of an inner peripheral wall of the second tube section 24C that are free of the lateral channel 21C. A partial inclined surface 27C is formed on an outer peripheral wall of a portion of the second tube section 24C that is adjacent to the first tube section 22C. The partial inclined surface 27C is an arcuate conical surface and is spaced apart from the first urging portion 13C of the sleeve housing 10C. At least a portion of the third tube section 26C extends outward from the axial hole 12C of the sleeve housing 10C. A through hole 264C is formed inside the third tube section 26C. The through hole 264C communicates with a space surrounded by the partial threaded portion 25C.

The pressing member 30C has a body 32C. The body 32C is a block having a shape matching the lateral channel 21C. The body 32C is mounted onto the lateral channel 21C and is radially slidable with respect to the central axis L. A pressing portion 321C is formed on a side of the body 32C that faces the partial threaded portion 25C. In the current embodiment, the pressing portion 321C is a portion of a thread and could cooperate with the partial threaded portion 25C of the screwing member 20C to jointly form a complete thread. In other embodiments, the pressing portion 321C could also be a portion of a tube wall.

The pressing portion 321C is basically flush with the inner peripheral wall of the second tube section 24C. In other embodiments, the pressing portion 321C could be slightly recessed relative to the inner peripheral wall of the second tube section 24C; in other words, the pressing portion 321C could be located within the lateral channel 21C. Another side of the body 32C that faces away from the partial threaded portion 25C. i.e., an outer side of the body 32C protrudes outward from the lateral channel 21C. A second urging portion 34C is formed on a portion of the outer side of the body 32C that faces the first urging portion 13C. The second urging portion 34C is configured to abut against the first urging portion 13C. The second urging portion 34C is spaced apart from the first urging portion 13C. In the current embodiment, the second urging portion 34C is an arcuate conical surface and abuts against the first urging portion 13C. In this way, when the sleeve housing 10C and the screwing member 20C move toward each other, the pressing member 30C is driven by the screwing member 20C to move toward the sleeve housing 10C, so that the second urging portion 34C could slide along the first urging portion 13C in a direction oblique to the central axis L.

A pair of radial elastic pieces 36C is formed on two circumferential sides of the body 32C. The radial elastic pieces 36C are elastic and respectively abut against the recesses 23C of the screwing member 20C. In this way, when the sleeve housing 10C and the screwing member 20C are driven by an external force to move toward each other, the pressing member 30C is driven by the screwing member 20C to move toward the sleeve housing 10C, so that the second urging portion 34C of the pressing member 30C is urged by the first urging portion 13C. Therefore, the body 32C is driven to radially move into the screwing member 20C with respect to the central axis L, and the pressing portion 321C is driven to move to a position that protrudes inward relative to the inner peripheral wall of the second tube section 24C, thereby enabling the pressing portion 321C to cooperate with the partial threaded portion 25C to press and engage with a bolt located inside the screwing member 20C. At the same time, the recesses 23C push the radial elastic pieces 36C to bend and deform, so that when the sleeve housing 10C and the screwing member 20C return to original positions and the second urging portion 34C is not urged by the first urging portion 13C, restoring forces of the radial elastic pieces 36C could push the body 32C of the pressing member 30C to return to an original position. At that time, the pressing portion 321C no longer presses the bolt.

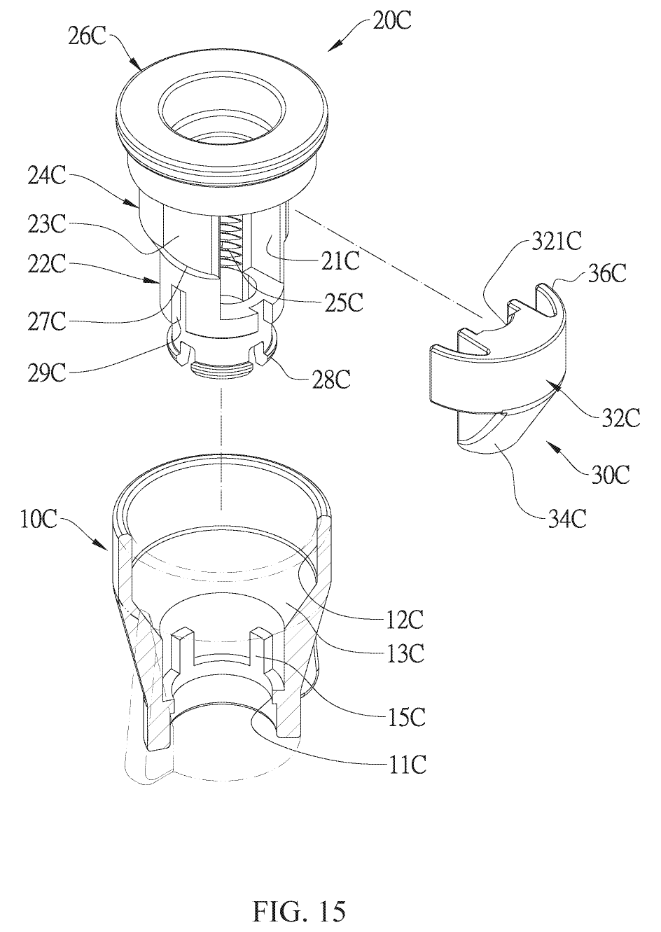

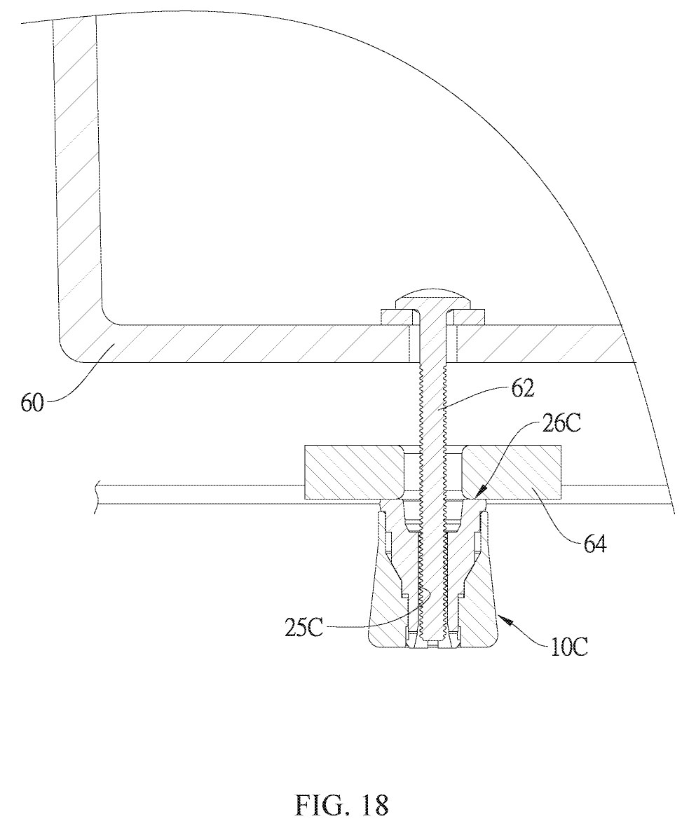

Referring to FIGS. 15, 17 and 18, and , when the single-bolt quick-install nut 100C of the fourth embodiment is used, the screwing member 20C is located on a top side of the single-bolt quick-install nut 100C and the sleeve housing 10C is located on a bottom side of the single-bolt quick-install nut 100C. When the single-bolt quick-install nut 100C is used to secure a tank 60, the tank 60 is mounted on a tank seat 64 of a toilet, the tank 60 is engaged with a bolt 62, and the bolt 62 extends downward through the tank seat 64 of the toilet. When used, the single-bolt quick-install nut 100C is sleeved around the bolt 62. The bolt 62 passes through the sleeve housing 10C and could be loosely engaged with the partial threaded portion 25C of the screwing member 20C. At the same time, the third tube section 26C of the screwing member 20C slightly abuts against a bottom side of the tank seat 64 of the toilet.

Afterward, a user directly rotates the sleeve housing 10C with hands to simultaneously rotate the screwing member 20C. When the user rotates the sleeve housing 10C, the user is also required to apply a force to move the sleeve housing 10C toward the screwing member 20C, so that the first urging portion 13C of the sleeve housing 10C urges the second urging portion 34C of the pressing member 30C. The second urging portion 34C is driven to slide along the first urging portion 13C in the direction oblique to the central axis L, thereby driving the body 32C of the pressing member 30C to move relatively into the lateral channel 21C. Therefore, the pressing portion 321C cooperates with the partial threaded portion 25C to form the complete thread and to engage with the bolt 62.

While the user rotates the sleeve housing 10C with hands to simultaneously rotate the screwing member 20C, the sleeve housing 10C moves upward relative to the screwing member 20C, so that the pressing portion 321C cooperates with the partial threaded portion 25C to form the complete thread and to engage with the bolt 62. Finally, due to the rotation of the sleeve housing 10C and the screwing member 20C, the third tube section 26C of the screwing member 20C is driven to move toward the tank seat 64 of the toilet and to tightly abut against a bottom side of the tank seat 64 of the toilet, so that the single-bolt quick-install nut 100C could be fastened to the bolt 64 through the screwing member 20C to provide a supporting effect to the tank seat 64 of the toilet, thereby securely positioning the tank 60.

At that time, the screwing member 20C is tightly clamped on the bottom side of the tank seat 64 of the toilet, so that the screwing member 20C could not shake relative to the bolt 62. In this way, after the single-bolt quick-install nut 100C is fastened to the bottom side of the tank seat 64 of the toilet, the screwing member 20C in a normal state would not leave a position of being fastened to the bolt 62 and would not be detached from the bolt 62 even if the force that drives the sleeve housing 10C to move upward is dismissed and the sleeve housing 10C no longer presses the pressing member 30C. The screwing member 20 would be unfastened only if a force for rotating the screwing member 20C relative to the bolt 62 is applied. Accordingly, the single-bolt quick-install nut 100C could firmly secure the tank 60.

When the single-bolt quick-install nut 100C is required to be detached from the bolt 62, the sleeve housing 10C is inversely rotated to drive the screwing member 20C to rotate simultaneously, so that the screwing member 20C could rotate along the bolt 62 and is dismissed from the state of tightly abutting against the bottom side of the tank seat 64 of the toilet. At that time, the partial threaded portion 25C of the screwing member 20C could be engaged with the bolt 62 only in a loose manner, so that the single-bolt quick-install nut 100C could be easily withdrawn from the bolt 62. While the single-bolt quick-install nut 100C is withdrawn from the bolt 62, the restoring forces provided by the radial elastic pieces 36C on the two sides of the pressing member 30C drive the body 32C to leave the lateral channel 21C, thereby preventing the pressing portion 321C from obstructing the movement of the bolt 62 within the screwing member 20C. With the aforementioned design, when the single-bolt quick-install nut of the present invention is fastened to the bolt 62, the installation could be completed by simultaneously rotating the sleeve housing 10C and the screwing member 20C with hands, thereby facilitating the user to operate the single-bolt quick-install nut within a confined space and to quickly fasten the single-bolt quick-install nut of the present invention to the bolt 62.

It must be pointed out that the embodiments described above are only some preferred embodiments of the present invention. All equivalent structures which employ the concepts disclosed in this specification and the appended claims should fall within the scope of the present invention.

What is claimed is:

1. A single-bolt quick-install nut, comprising:
a sleeve housing having an engaging ring and an axial hole, wherein the axial hole extends along a central axis; a first urging portion is formed on an inner peripheral wall of the axial hole; the engaging ring and the first urging portion are spaced apart from each other along the central axis;
a screwing member comprising a first tube section, a second tube section, and a third tube section that are coaxially arranged and are sequentially connected along the central axis, wherein an outer diameter of the first tube section is less than an outer diameter of the second tube section; an end edge of the first tube section that faces away from the second tube section is connected to an engaging hook; the first tube section passes through the axial hole and the engaging hook is hooked onto a side of the engaging ring that faces away from the first urging portion; a lateral channel is formed and penetrates through a side of a periphery of the first tube section and a side of a periphery of the second tube section; a pair of recesses is formed in an outer peripheral wall of the second tube section at two circumferential sides of the lateral channel; a partial threaded portion is formed on a portion of an inner peripheral wall of the first tube section and a portion of an inner peripheral wall of the second tube section that are free of the lateral channel; and
a pressing member having a body that is fitted into the lateral channel and is radially slidable with respect to the central axis, wherein a pressing portion is formed on a side of the body that faces the partial threaded portion; another side of the body that faces away from the partial threaded portion protrudes outward relative to the lateral channel; a second urging portion is formed on the another side of the body that faces away from the partial threaded portion; the second urging portion is configured to abut against the first urging portion; the second urging portion is slidable along the first urging portion in a direction oblique to the central axis; a pair of radial elastic pieces is formed on two circumferential sides of the body; each of the radial elastic pieces is elastic and abuts against a corresponding one of the recesses.

2. The single-bolt quick-install nut as claimed in claim 1, wherein the outer diameter of the second tube section is less than an outer diameter of the third tube section; a supporting surface is formed on an outer peripheral wall of a portion of the third tube section adjacent to the second tube section; the supporting surface is an annular conical surface; an outer diameter of a side of the supporting surface that is adjacent to the second tube section is less than an outer diameter of another side of the supporting surface that is away from the second tube section; the sleeve housing has a cap; the first urging portion is located on an inner side of the cap; an end edge of the cap that is adjacent to the supporting surface is connected to a plurality of axial elastic pieces; the axial elastic pieces are arranged in a circle and are elastic; each of the axial elastic pieces has a free end; the free ends of the axial elastic pieces abut against the supporting surface.

3. The single-bolt quick-install nut as claimed in claim 2, wherein the sleeve housing further comprises a gasket; the gasket abuts against an end of the cap that faces away from the axial elastic pieces; the engaging ring is formed at a middle of the gasket; the axial hole is formed on the inner side of the cap; the first urging portion is formed on a side of the axial hole that is away from the gasket.

4. The single-bolt quick-install nut as claimed in claim 2, wherein the sleeve housing further comprises a straight tube; the straight tube is coaxial with the cap and is connected to an end of the cap that faces away from the axial elastic pieces; the engaging ring is formed on an inner peripheral wall of the straight tube; the axial hole is formed on the inner side of the cap; the first urging portion is formed on a side of the axial hole that is away from the straight tube.

5. The single-bolt quick-install nut as claimed in claim 1, wherein the first urging portion is an annular conical surface; the second urging portion is an arcuate conical surface.

6. The single-bolt quick-install nut as claimed in claim 1, wherein the first urging portion comprises a plurality of circular edges arranged at intervals along the central axis; the circular edges are coaxial; the farther each circular edge is from the engaging ring, the greater a diameter of the circular edge is; the second urging portion is an arcuate conical surface.

7. The single-bolt quick-install nut as claimed in claim 1, wherein a plurality of anti-slip grooves is formed in an outer peripheral wall of the third tube section; the anti-slip grooves are arranged around the central axis.

8. The single-bolt quick-install nut as claimed in claim 1, wherein a partial inclined surface is formed on an outer peripheral wall of a portion of the second tube section that is adjacent to the first tube section; the partial inclined surface is an arcuate conical surface and is spaced apart from the first urging portion; an interval between the partial inclined surface and the first urging portion is greater than an interval between the second urging portion and the first urging portion.

9. The single-bolt quick-install nut as claimed in claim 1, wherein the pressing portion is a portion of a tube wall or a portion of a thread; the pressing portion is either flush with or recessed relative to the inner peripheral wall of the second tube section.

10. A single-bolt quick-install nut, comprising:
a sleeve housing, wherein an interior of the sleeve housing has an axial hole; the axial hole extends along a central axis; an engaging ring, a plurality of sliding blocks, and a first urging portion are formed on an inner peripheral wall of the axial hole; the engaging ring and the first urging portion are spaced apart from each other along the central axis; the sliding blocks are located between the engaging ring and the first urging portion;
a screwing member comprising a first tube section, a second tube section, and a third tube section that are coaxially arranged and are sequentially connected along the central axis, wherein an outer diameter of the first tube section is less than an outer diameter of the second tube section; an end edge of the first tube section that faces away from the second tube section is connected to an engaging hook; a plurality of rails is formed on the end edge of the first tube section that faces away from the second tube section and is circumferentially arranged; the rails are elongated grooves extending along the central axis and respectively receive the sliding blocks; the first tube section passes through the axial hole and the engaging hook is hooked onto a side of the engaging ring that faces away from the first urging portion; a lateral channel is formed and penetrates through a side of a periphery of the first tube section and a side of a periphery of the second tube section; a pair of recesses is formed in an outer peripheral wall of the second tube section at two circumferential sides of the lateral channel; a partial threaded portion is formed on a portion of an inner peripheral wall of the first tube section and a portion of an inner peripheral wall of the second tube section that are free of the lateral channel; at least a portion of the third tube section extends outward from the sleeve housing; and
a pressing member having a body that is fitted into the lateral channel and is radially slidable with respect to the central axis, wherein a pressing portion is formed on a side of the body that faces the partial threaded portion; another side of the body that faces away from the partial threaded portion protrudes outward relative to the lateral channel; a second urging portion is formed on the another side of the body that faces away from the partial threaded portion; the second urging portion is configured to abut against the first urging portion; the second urging portion is slidable along the first urging portion in a direction oblique to the central axis; a pair of radial elastic pieces is formed on two circumferential sides of the body; each of the radial elastic pieces is elastic and abuts against a corresponding one of the recesses.

11. The single-bolt quick-install nut as claimed in claim 10, wherein a plurality of operating blocks is formed on an outer peripheral wall of the sleeve housing; the first urging portion is an annular conical surface; the second urging portion is an arcuate conical surface.

12. The single-bolt quick-install nut as claimed in claim 10, wherein the pressing portion is a portion of a tube wall or a portion of a thread; the pressing portion is either flush with or recessed relative to the inner peripheral wall of the second tube section.

13. The single-bolt quick-install nut as claimed in claim 10, wherein a partial inclined surface is formed on an outer peripheral wall of a portion of the second tube section that is adjacent to the first tube section; the partial inclined surface is an arcuate conical surface and is spaced apart from the first urging portion.
